(19) United States
(12) Patent Application Publication
(10) Pub. No.: US 2020/0056064 A1
(43) Pub. Date: Feb. 20, 2020

(54) COATING COMPOSITION

(71) Applicant: SOLVAY SPECIALTY POLYMERS ITALY S.P.A., Bollate (IT)

(72) Inventors: Stefano BOSSOLO, Parabiago (IT); Serena CARELLA, Parabiago (IT); Eliana IEVA, Alessandria (IT); Fulvia RONCATI, Alessandria (IT)

(21) Appl. No.: 16/345,660

(22) PCT Filed: Oct. 17, 2017
(86) PCT No.: PCT/EP2017/076480

§ 371 Date: Apr. 26, 2019

(30) Foreign Application Priority Data
Oct. 28, 2016 (EP) 16196230.3

(51) Int. Cl. C09D 127/16

(52) U.S. Cl. CPC C09D 127/16; C08K 5/34

(57) ABSTRACT

The invention relates to a coating composition obtained by mixing aqueous latexes of VDF polymers with certain pyridinium salts, to a method of coating a substrate using the same, and to coated layers derived there from, and to its use for the manufacture of electrochemical cell components, such as electrodes and/or composite separators.

### CROSS-REFERENCE TO RELATED APPLICATION

This application claims priority to European application No. 16196230.3 filed on Oct. 28, 2016, the whole content of this application being incorporated herein by reference for all purposes.

### TECHNICAL FIELD

The invention relates to a coating composition, to a method of making the same, and to its use for the manufacture of electrochemical cell components, such as electrodes and/or composite separators

### BACKGROUND ART

Vinylidene fluoride (VDF) polymers are known in the art to be suitable for use in a variety of coating applications (e.g. for architectural coatings or in the chemical processing industry), and in other advanced fields of use, including as binders for the manufacture of electrodes and/or composite separators, and/or as coatings of porous separators for use in non-aqueous-type electrochemical devices such as batteries, preferably secondary batteries, and electric double layer capacitors.

While these fields of use may appear as quite diversified, in all of them, beside adhesion to substrates/fillers/active materials, the VDF polymers are expected to deliver strong cohesion, improved stability/non-dissolution towards chemicals (including e.g. liquid electrolyte solutions) and improved mechanical properties. Hence, techniques for creating three-dimensional polymer networks through crosslinking have captured attention to address these challenges, as they can bring substantial improvement in cohesive ability and in chemical/mechanical resistance.

In this field, hence, a continuous quest exists for compositions of VDF polymers possessing all required properties for being used in the field of coating and/or in the field of components for secondary batteries, and yet possessing ability to deliver improved cohesion, notably with fillers and pigments, electrode active materials and/or with composite separators' inorganic fillers, improved chemical resistance and mechanical performances.

Also, in the domain of VDF polymer-based crosslinkable formulations, the ability for the coating composition to be stored for a reasonable time before being actually used and applied to deliver the expected performances as a coating ingredient is quite often in contrast with the fast crosslinking ability which same coating composition has to deliver when processed and applied. There's hence a continuous quest for coating compositions possessing adequate shelf-life, and yet delivering outstanding performances in curing, upon processing.

### SUMMARY OF INVENTION

The Applicant has now found that certain coating compositions obtained by mixing aqueous latexes of VDF polymers with certain pyridinium salts and certain bases are effective for solving the afore-mentioned technical problems.

It is hence a first object of the present invention an aqueous composition [composition (C)] obtained by mixing:
an aqueous latex comprising particles of at least one vinylidene-fluoride (VDF) based fluoropolymer comprising recurring units derived from vinylidene fluoride (VDF) and optionally from at least one additional comonomer different from VDF [polymer (A)];
at least one basic compound [base (B)];
at least one pyridinium salt [salt (P)] complying with any of formulae (P1) to (12):

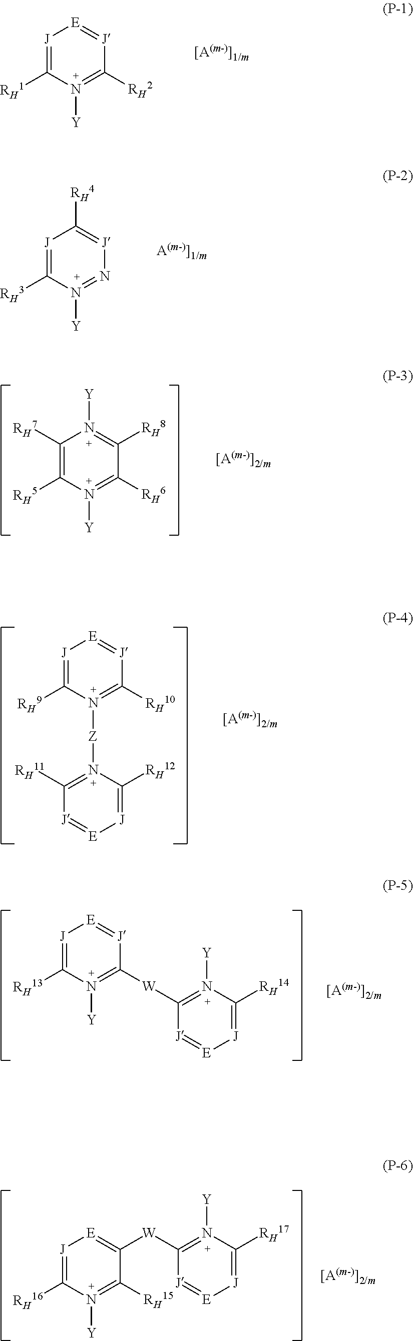

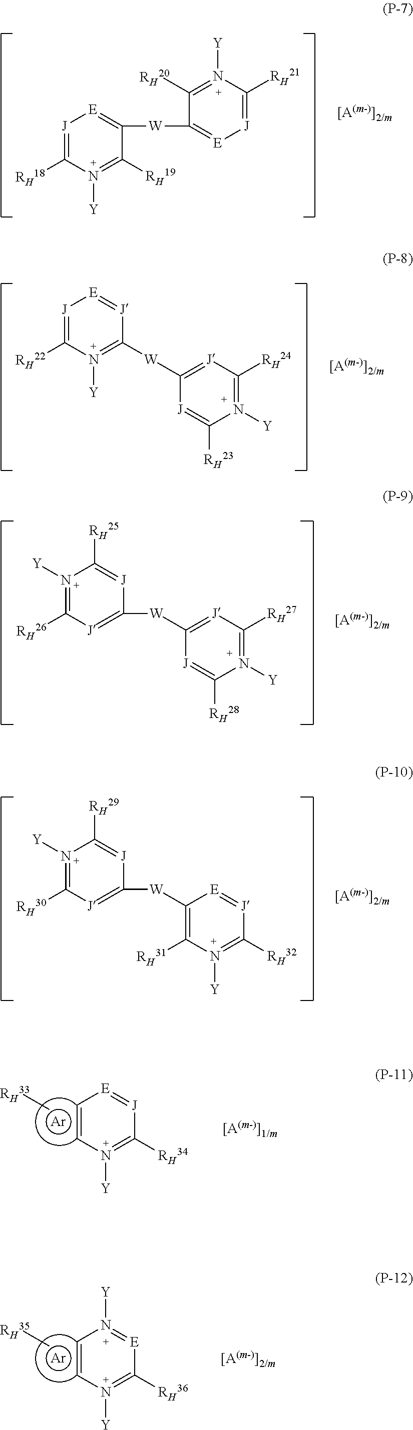

wherein:
each of J and J′, equal to or different from each other, is independently at each occurrence C—R* or N, wherein R* is H or a C₁-C₁₂ hydrocarbon group;
E is N or a group of formula C—R^{∘}_{H};
Z is a divalent hydrocarbon group comprising from 1 to 12 carbon atoms;
W is a bond or is a bridging group selected from the group consisting of divalent hydrocarbon groups comprising from 1 to 12 carbon atoms (preferably divalent aliphatic groups comprising from 1 to 6 carbon atoms) and divalent fluorocarbon groups comprising from 1 to 12 carbon atoms (preferably divalent perfluoroaliphatic groups comprising from 1 to 6 carbon atoms);
the group sketched with symbol:

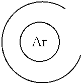

in formula (P-11) and (P-12) designates an aromatic mono- or poly-nuclear ring condensed to the pyridinium-type aromatic ring, which may comprise one or more additional nitrogen atoms, optionally quaternized nitrogen atoms, in the ring(s);
each of R¹_{H}, R²_{H}, R³_{H}, R⁴_{H}, R⁵_{H}, R⁶_{H}, R⁷_{H}, R⁸_{H}, R⁹_{H}, R¹⁰_{H}, R¹¹_{H}, R¹²_{H}, R¹³_{H}, R¹⁴_{H}, R¹⁵_{H}, R¹⁶_{H}, R¹⁷_{H}, R¹⁸_{H}, R¹⁹_{H}, R²⁰_{H}, R²¹_{H}, R²²_{H}, R²³_{H}, R²⁴_{H}, R²⁵_{H}, R²⁶_{H}, R²⁷_{H}, R²⁸_{H}, R²⁹_{H}, R³⁰_{H}, R³¹_{H}, R³²_{H}, R³³_{H}, R³⁴_{H}, R³⁵_{H}, R³⁶_{H} and R^{∘}_{H}, equal to or different from each other, is independently at each occurrence —H or a group of formula [group (alpha-H)]:

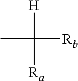

wherein Rₐ, and R_{b}, equal to or different from each other, are independently H or a hydrocarbon C₁-C₆ group;
Y, equal to or different from each other, is independently oxygen or a C₁-C₁₂ hydrocarbon group, which can be notably an aliphatic or an aromatic group, which can comprise one or more than one heteroatoms selected from N, O, S and halogens;
A^{(m-)} is an anion having valency m;
   with the proviso that
   (i) when salt (P) is of formula (P-1) at least two of R¹_{H}, R²_{H}, and R^{∘}_{H} are groups (alpha-H);
   (ii) when salt (P) is of formula (P-2) R³_{H} and R⁴_{H} are groups (alpha-H);
   (iii) when salt (P) is of formula (P-3), at least two of R⁵_{H}, R⁶_{H}, R⁷_{H}, and R⁸_{H} are groups (alpha-H);
   (iv) when salt (P) is of formula (P-4), at least two of R⁹_{H}, R¹⁰_{H}, R¹¹_{H}, R¹²_{H}, and R^{∘}_{H} are groups (alpha-H);
   (v) when salt (P) is of formula (P-5), at least two of R¹³_{H}, R¹⁴_{H}, and R^{∘}_{H} are groups (alpha-H);
   (vi) when salt (P) is of formula (P-6), at least two of R¹⁵_{H}, R¹⁶_{H}, R¹⁷_{H}, and R^{∘}_{H} are groups (alpha-H);
   (vii) when salt (P) is of formula (P-7), at least two of R¹⁸_{H}, R¹⁹_{H}, R²⁰_{H}, R²¹_{H}, and R^{∘}_{H} are groups (alpha-H);
   (viii) when salt (P) is of formula (P-8), at least two of R²²_{H}, R²³_{H}, R²⁴_{H}, and R^{∘}_{H} are groups (alpha-H);
   (ix) when salt (P) is of formula (P-9), at least two of R²⁵_{H}, R²⁶_{H}, R²⁷_{H}, and R²⁸_{H} are groups (alpha-H);
   (x) when salt (P) is of formula (P-10), at least two of R²⁹_{H}, R³⁰_{H}, R³¹_{H}, R³²_{H}, and R²⁸_{H} are groups (alpha-H);
   (xi) when salt (P) is of formula (P-11), at least two of R³³_{H}, R³⁴_{H}, and R²⁸_{H} are groups (alpha-H);
   (xii) when salt (P) is of formula (P-12), at least two of R³⁵_{H}, R³⁶_{H} and R^{∘}_{H} are groups (alpha-H).

The group alpha-H comprises a central carbon atom which bears at least a hydrogen atom and which is covalently bound to a sp²-hybridized carbon of the pyridinium-ring (annular carbon): as the annular carbon is in ortho or para position to the quaternized nitrogen of the pyridinium ring, the hydrogen atom(s) of the group alpha-H possess(es) suitable reactivity to generate, under certain conditions, corresponding carbanions.

The Applicant has surprisingly found that salts (P) of any of formulae (P-1) to (P-12) including a ring-quaternized pyridinium-type nitrogen, and possessing at least two groups in ortho or para position with respect to the said ring-quaternized pyridinium-type nitrogen comprising said reactive hydrogen atoms, when combined with basic compounds in an aqueous medium, are effective cross-linking agents for the cross-linking of VDF polymers. More specifically, upon casting, cross-linking has been proven to proceed effectively, delivering coated layers possessing improved cohesion, notably with fillers and pigments, electrode active materials and/or with composite separators' inorganic fillers, improved chemical resistance and mechanical performances.

Without being bound by this theory, the Applicant thinks that the groups in the said ortho or para position comprising at least one hydrogen atom in alpha position with respect to the aromatic ring possess acidic character, so as to give rise, in the presence of the base (B), to corresponding carbanion; the so formed carbanions have sufficient reactivity/nucleophilic character to ensure activation and grafting of the VDF polymer chain, so as to generate a three-dimensional crosslinked network in the coated films and layers obtained therefrom.

### DESCRIPTION OF INVENTION

The aqueous composition (C) of the invention is obtained by mixing a latex of polymers (A) with the salt (P) and the base (B), as above detailed.

The expression “latex” is hereby used according to its general meaning in the art, that is to say to designate stable dispersions of particles of polymer (A) in an aqueous medium. A latex is thus distinguishable notably from an aqueous slurry that can be prepared by dispersing powders a polymer in an aqueous medium and/or from a solution in a solvent able to swell or dissolve polymer (A).

The term “aqueous medium” is hereby used according to its usual meaning, i.e. intended to designate a liquid phase predominantly composed of water, being understood that minor amounts of one or more organic solvent(s), e.g. amounts of 1% wt or less, may be present without the same affecting the aqueous nature of the medium.

Polymer (A) comprises recurring units derived from vinylidene fluoride (VDF) and optionally from at least one additional comonomer different from VDF.

More specifically, according to certain embodiments, polymer (A) comprises:
recurring units derived from vinylidene fluoride (VDF) in an amount ranging from 60 to 100% moles, preferably 65 to 100% moles, more preferably 75 to 100% moles,
and optionally, recurring units derived from at least one additional comonomer [comonomer (C)] different from VDF, in an amount ranging from 0 to 40% moles, preferably 0 to 35% moles, more preferably 0 to 25% moles.

The comonomer (C) can be either a hydrogenated comonomer [comonomer (H)] or a fluorinated comonomer [comonomer (F)].

By the term “hydrogenated comonomer [comonomer (H)]”, it is hereby intended to denote an ethylenically unsaturated comonomer free of fluorine atoms.

Non-limitative examples of suitable hydrogenated comonomers (H) include, notably, ethylene, propylene, vinyl monomers such as vinyl acetate, acrylic monomers, as well as styrene monomers, like styrene and p-methylstyrene.

By the term “fluorinated comonomer [comonomer (F)]”, it is hereby intended to denote an ethylenically unsaturated comonomer comprising at least one fluorine atom.

The comonomer (C) is preferably a fluorinated comonomer [comonomer (F)].

Non-limitative examples of suitable fluorinated comonomers (F) include, notably, the followings:

(a) C₂-C₈ perfluoroolefins such as tetrafluoroethylene (TFE), hexafluoropropylene (HFP);
(b) C₂-C₈ hydrogen-containing fluoroolefins such as vinyl fluoride, 1,2-difluoroethylene, trifluoroethylene, pentafluoropropylene and hexafluoroisobutylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE);
(e) (per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
(g) fluoroalkyl-methoxy-vinylethers of formula CF₂═CFOCF₂OR_{f2}, wherein R_{f2} is a C₁-C₆ fluoro- or perfluoroalkyl group, e.g. —CF₃, —C₂F₅, —C₃F₇ or a C₁-C₆ (per)fluorooxyalkyl group having one or more ether groups, e.g. —C₂ F₅—O—CF₃;
(h) fluorodioxoles of formula:

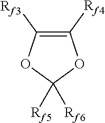

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃.

Most preferred fluorinated comonomers (F) are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride, and among these, HFP is most preferred.

According to certain embodiment's, polymer (A) comprises recurring units derived from derived from vinylidene fluoride (VDF) and from at least one hydrophilic (meth)acrylic monomer (MA), possibly in combination with one or more than one fluorinated comonomer (F).

The term “at least one hydrophilic (meth)acrylic monomer (MA)” is understood to mean that the polymer (A) may comprise recurring units derived from one or more than one hydrophilic (meth)acrylic monomer (MA) as above described. In the rest of the text, the expressions “hydrophilic (meth)acrylic monomer (MA)” and “monomer (MA)” are understood, for the purposes of the present invention, both in the plural and the singular, that is to say that they denote both one or more than one hydrophilic (meth)acrylic monomer (MA).

According to certain embodiments, polymer (A) consists essentially of recurring units derived from VDF, and from monomer (MA).

According to other embodiments, polymer (A) consists essentially of recurring units derived from VDF, from HFP and from monomer (MA).

Polymer (A) may still comprise other moieties such as defects, end-groups and the like, which do not affect nor impair its physico-chemical properties.

The hydrophilic (meth)acrylic monomer (MA) preferably complies formula:

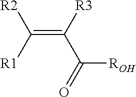

wherein each of R1, R2, R3, equal or different from each other, is independently an hydrogen atom or a C₁-C₃ hydrocarbon group, and R_{OH} is a hydroxyl group or a C₁-C₅ hydrocarbon moiety comprising at least one hydroxyl group; more preferably, each of R1, R2, R3 are hydrogen, and R OH has the same meaning as above detailed, preferably R_{OH} is OH.

Non limitative examples of hydrophilic (meth)acrylic monomers (MA) are notably acrylic acid, methacrylic acid, hydroxyethyl (meth)acrylate, hydroxypropyl(meth)acrylate; hydroxyethylhexyl(meth)acrylates.

The monomer (MA) is more preferably selected among:
hydroxyethylacrylate (HEA) of formula:

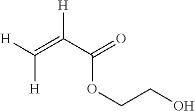

2-hydroxypropyl acrylate (HPA) of either of formulae:

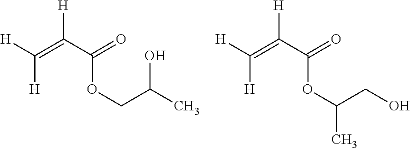

acrylic acid (AA) of formula:

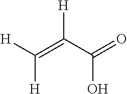

and mixtures thereof.

More preferably, the monomer (MA) is AA and/or HEA, even more preferably is AA.

Determination of the amount of (MA) monomer recurring units in polymer (A) can be performed by any suitable method. Mention can be notably made of acid-base titration methods, well suited e.g. for the determination of the acrylic acid content, of NMR methods, adequate for the quantification of (MA) monomers comprising aliphatic hydrogens in side chains (e.g. HPA, HEA), of weight balance based on total fed (MA) monomer and unreacted residual (MA) monomer during polymer (A) manufacture.

According to these embodiment's polymer (A) comprises preferably at least 0.1, more preferably at least 0.2% moles of recurring units derived from said hydrophilic (meth)acrylic monomer (MA) and/or polymer (A) comprises preferably at most 10, more preferably at most 7.5% moles, even more preferably at most 5% moles, most preferably at most 3% moles of recurring units derived from said hydrophilic (meth)acrylic monomer (MA).

According to these embodiment's, polymer (A) possesses generally a melt viscosity (MV) of at least 15 kPoise, when determined at a shear rate of 100 sec⁻¹, and at a temperature of 230° C., according to ASTM D3835. The MV of polymer (A) is not particularly limited, but it is generally understood that MV of no more than 100 kPoise, preferably less than 80 kPoise will be adequate for ensuring optimal properties in coating applications.

According to certain embodiments, said polymer (A) comprising recurring units derived from vinylidene fluoride (VDF) and optionally from at least one additional comonomer different from VDF is a fluoroelastomer [fluoroelastomer (A)].

For the purposes of this invention, the term “fluoroelastomer” [fluoroelastomer (A)] is intended to designate a fluoropolymer resin serving as a base constituent for obtaining a true elastomer, said fluoropolymer resin comprising more than 10% wt, preferably more than 30% wt, of recurring units derived from VDF and from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer). True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Fluoroelastomers (A) are in general amorphous products or products having a low degree of crystallinity (crystalline phase less than 20% by volume) and a glass transition temperature (Tg) below room temperature. In most cases, the fluoroelastomer (A) has advantageously a Tg below 10° C., preferably below 5° C., more preferably 0° C., even more preferably below −5° C.

Fluoroelastomer (A) typically comprises at least 15% moles, preferably at least 20% moles, more preferably at least 35% moles of recurring units derived from VDF, with respect to all recurring units of the fluoroelastomer.

Fluoroelastomer (A) typically comprises at most 85% moles, preferably at most 80% moles, more preferably at most 78% moles of recurring units derived from VDF, with respect to all recurring units of the fluoroelastomer.

Non limitative examples of suitable (per)fluorinated monomers, recurring units derived therefrom being comprised in the fluoroelastomer (A), are notably:

(a) C₂-C₈ perfluoroolefins, such as tetrafluoroethylene (TFE) and hexafluoropropylene (HFP);
(b) hydrogen-containing C₂-C₈ olefins different from VDF, such as vinyl fluoride (VF), trifluoroethylene (TrFE), perfluoroalkyl ethylenes of formula CH₂═CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per)fluoroalkylvinylethers (PAVE) of formula CF₂═CFOR_{f}, wherein R_{f} is a C₁-C₆ (per)fluoroalkyl group, e.g. CF₃, C₂F₅, C₃F₇;
(e) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;
(f) (per)fluorodioxoles having formula:

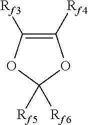

wherein R_{f3}, R_{f4}, R_{f5}, R_{f6}, equal or different from each other, are independently selected among fluorine atoms and C₁-C₆ (per)fluoroalkyl groups, optionally comprising one or more than one oxygen atom, such as notably —CF₃, —O₂F₅, —C₃F₇, —OCF₃, —OCF₂CF₂OCF₃; preferably, perfluorodioxoles;
(g) (per)fluoro-methoxy-vinylethers (MOVE, hereinafter) having formula: CFX₂═CX₂OCF₂OR″_{f}
wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂═F, H; preferably X₂ is F and R″_{f} is —CF₂CF₃ (MOVE1); —CF₂CF₂OCF₃ (MOVE2); or —CF₃ (MOVE3).

It is generally preferred for the fluoroealstomer (A) to comprise, in addition to recurring units derived from VDF, recurring units derived from HFP.

In this case, fluoroelastomer (A) typically comprises at least 10% moles, preferably at least 12% moles, more preferably at least 15% moles of recurring units derived from HFP, with respect to all recurring units of the fluoroelastomer.

Still, fluoroelastomer (A) typically comprises at most 45% moles, preferably at most 40% moles, more preferably at most 35% moles of recurring units derived from HFP, with respect to all recurring units of the fluoroelastomer.

Fluoroelastomers (A) suitable in the compositions of the invention may comprise, in addition to recurring units derived from VDF and HFP, one or more of the followings:
recurring units derived from at least one bis-olefin [bis-olefin (OF)] having general formula:

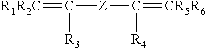

wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per)fluoropolyoxyalkylene radical;
recurring units derived from at least one (per)fluorinated monomer different from VDF and HFP; and
recurring units derived from at least one hydrogenated monomer.

Examples of hydrogenated monomers are notably non-fluorinated alpha-olefins, including ethylene, propylene, 1-butene, diene monomers, styrene monomers, alpha-olefins being typically used. C₂-C₈ non-fluorinated alpha-olefins (OI), and more particularly ethylene and propylene, will be selected for achieving increased resistance to bases.

The bis-olefin (OF) is preferably selected from the group consisting of those complying with formulae (OF-1), (OF-2) and (OF-3):

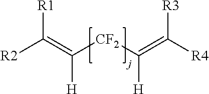

wherein j is an integer between 2 and 10, preferably between 4 and 8, and R1, R2, R3, R4, equal or different from each other, are H, F or C₁₋₅ alkyl or (per)fluoroalkyl group;

### (OF-2)

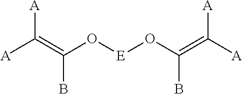

wherein each of A, equal or different from each other and at each occurrence, is independently selected from F, Cl, and H; each of B, equal or different from each other and at each occurrence, is independently selected from F, Cl, H and ORB, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

### (OF-3)

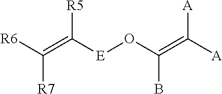

wherein E, A and B have the same meaning as above defined; R5, R6, R7, equal or different from each other, are H, F or C₁₋₅ alkyl or (per)fluoroalkyl group.

Most preferred fluoroelastomers (A) are those having following compositions (in mol % with respect to total moles of units of fluoroelastomer):

(i) vinylidene fluoride (VDF) 45-85%; hexafluoropropene (HFP) 15-45%; tetrafluoroethylene (TFE) 0-30%;
(ii) vinylidene fluoride (VDF) 20-30%; hexafluoropropene (HFP) 18-27%; C₂-C₈ non-fluorinated olefins (01) 5-30%; perfluoroalkyl vinyl ethers (PAVE) 0-35%; bis-olefin (OF) 0-5%;
(iii) vinylidene fluoride (VDF) 60-75%; hexafluoropropene (HFP) 10-25%; tetrafluoroethylene (TFE) 0-20%; perfluoroalkyl vinyl ethers (PAVE) 1-15%.

Whichever is the nature of polymer (A), generally, particles of polymer (A) possess a primary particle average size of less than 1 μm. For the purpose of the present invention, the term “primary particles” is intended to denote primary particles of polymer (A) deriving directly from aqueous emulsion polymerization, without isolation of the polymer from the latex (i.e. the stabilized emulsion of particles). Primary particles of polymer (A) are thus to be intended distinguishable from agglomerates (i.e. collection of primary particles), which might be obtained by recovery and conditioning steps of such polymer manufacture such as concentration and/or coagulation of aqueous latexes of the polymer (A) and subsequent drying and homogenization to yield the respective powder.

Preferably, the primary particles average size of the particles of polymer (A) in dispersion (D) is above 20 nm, more preferably above 30 nm, even more preferably above 50 nm, and/or is below to 600 nm, more preferably below 400 and even more preferably below 350 nm as measured according to ISO 13321.

Preferred salts (P) of formula (P-1) are those complying with formulae (P-1-a) to (P-1-e):

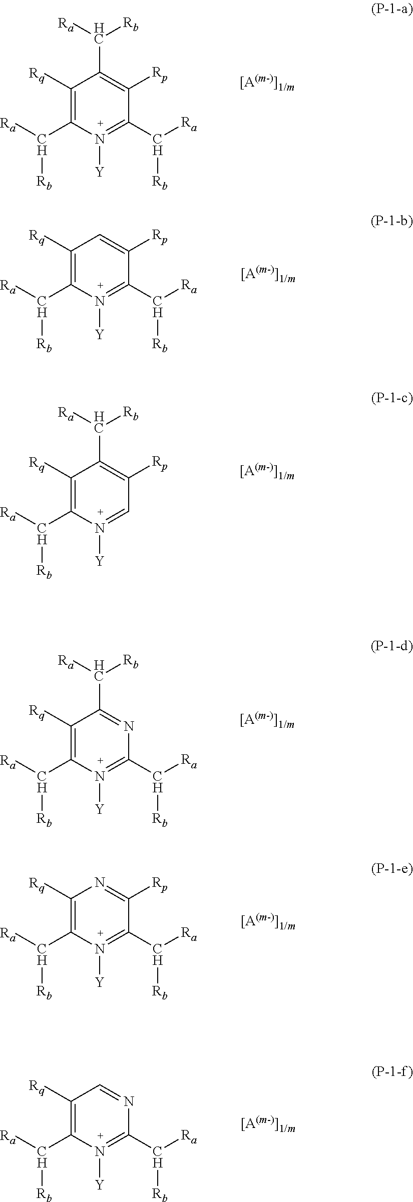

wherein:
Rₐ and R_{b} have the meaning as above defined, preferably Rₐ and R_{b} are H;
Y has the meaning as defined above, preferably Y is methyl;
each of Rₚ and R_{q}, equal to or different from each other, is H or a C₁-C₁₂ hydrocarbon group;
A and m have the meanings as above defined.

More preferably, salts (P) of formula (P-1) are those having any of formulae (P-1-g) to (P-1-p):

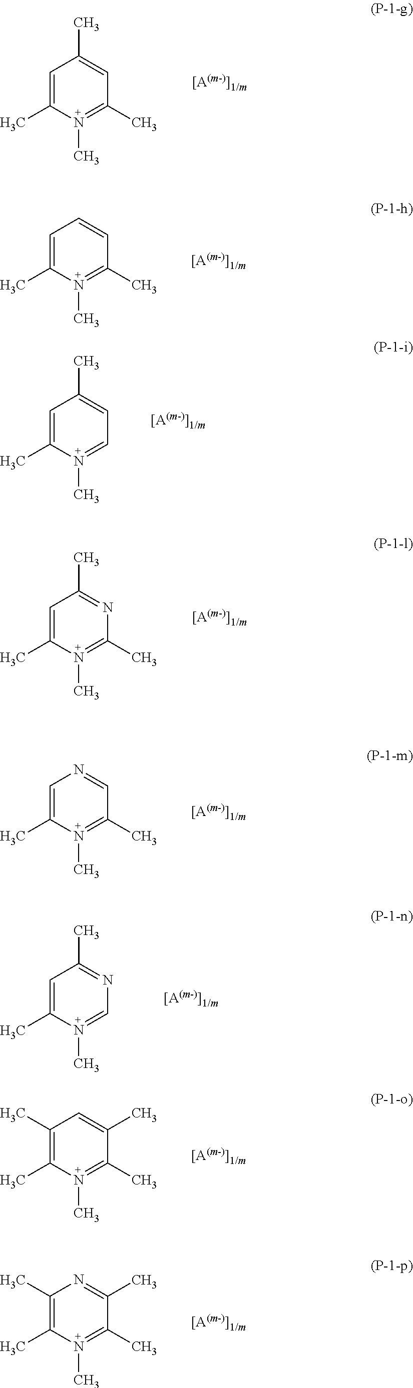

wherein A and m have the meaning as above detailed.

Preferred salts (P) of formula (P-2) are those complying with formula (P-2-a):

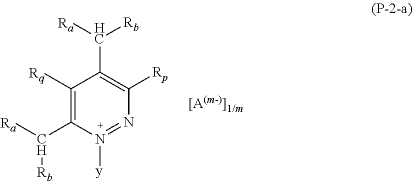

wherein:
Rₐ and R_{b} have the meaning as above defined, preferably Rₐ and R_{b} are H;
Y has the meaning as defined above, preferably Y is methyl;
each of Rₚ and R_{q}, equal to or different from each other, is H or a C₁-C₁₂ hydrocarbon group;
A and m have the meanings as above defined.

More preferably, salts (P) of formula (P-2) are those having formula (P-2-b)

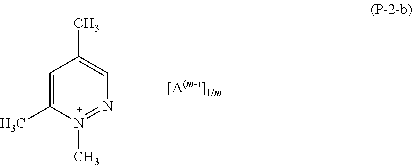

wherein A and m have the meaning as above detailed.

Preferred salts (P) of formula (P-3) are those complying with formula (P-3-a):

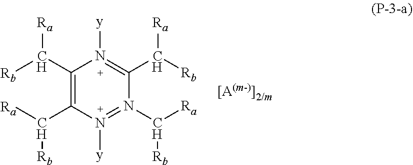

wherein:
Rₐ and R_{b} have the meaning as above defined, preferably Rₐ and R_{b} are H;
Y has the meaning as defined above, preferably Y is methyl;
A and m have the meanings as above defined.

More preferably, salts (P) of formula (P-3) are those having formula (P-3-b)

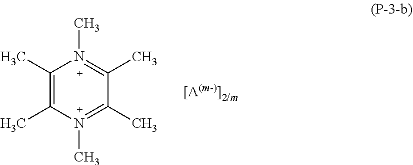

wherein A and m have the meaning as above detailed.

Preferred salts (P) of formula (P-4) are those complying with formula (P-4-a):

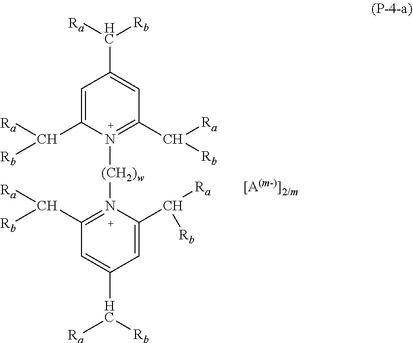

wherein:
Rₐ and R_{b} have the meaning as above defined, preferably Rₐ and R_{b} are H;
w is an integer of 1 to 12, preferably of 1 to 6, most preferably equal to 3;
A and m have the meanings as above defined.

More preferably, salts (P) of formula (P-4) are those having formula (P-4-b) or (P-4-c):

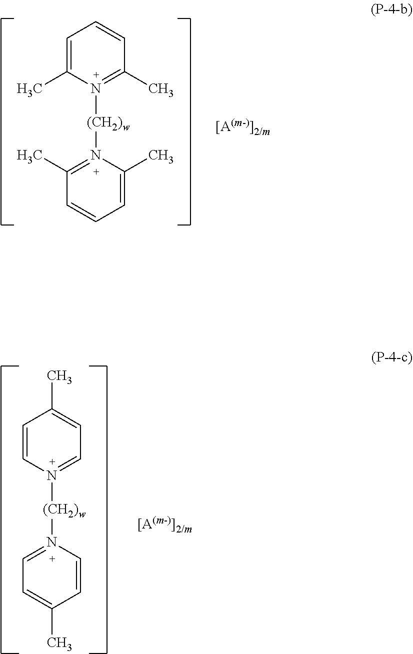

wherein A, and m have the meaning as above detailed, and w=3.

Preferred salts (P) of formula (P-5) are those complying with formula (P-5-a):

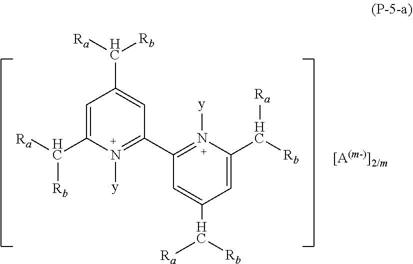

wherein:
Rₐ and R_{b} have the meaning as above defined, preferably Rₐ and R_{b} are H;
Y has the meaning as defined above, preferably Y is methyl;
A and m have the meanings as above defined.

More preferably, salts (P) of formula (P-5) are those having formula (P-5-b) or (P-5-c):

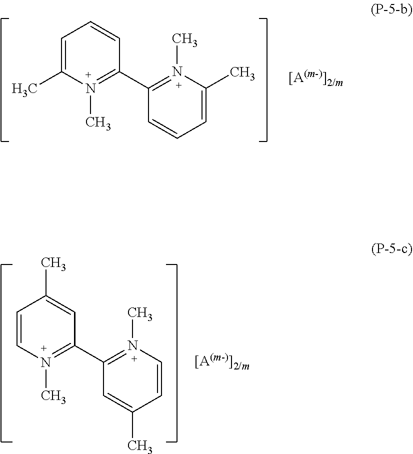

wherein A and m have the meaning as above detailed.

Preferred salts (P) of formula (P-11) are those complying with formula (P-11-a):

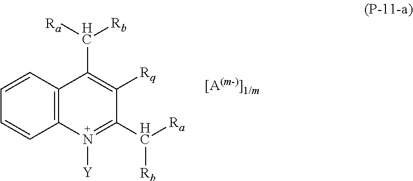

wherein:
Rₐ and R_{b} have the meaning as above defined, preferably Rₐ and R_{b} are H;
Y has the meaning as defined above, preferably Y is methyl;
A and m have the meanings as above defined.

More preferably, salts (P) of formula (P-11) are those having formula (P-11-b):

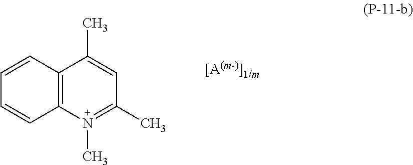

wherein A and m have the meaning as above detailed.

Preferred salts (P) of formula (P-12) are those complying with formula (P-12-a):

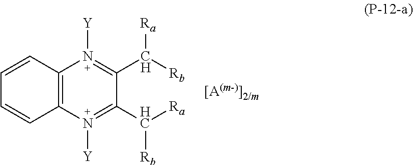

wherein:
Rₐ and R_{b} have the meaning as above defined, preferably Rₐ and R_{b} are H;
Y has the meaning as defined above, preferably Y is methyl;
A and m have the meanings as above defined.

More preferably, salts (P) of formula (P-12) are those having formula (P-12-b):

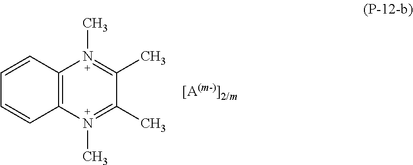

wherein A and m have the meaning as above detailed.

The choice of the anion A in formulae (P-1) to (P-12) is not particularly critical; it is nevertheless understood that anions selected from the group consisting of arylsulfonates, in particular, tosylate (p-toluensulfonate), (fluoro)alkyl sulfonates having a C₁-C₆ (fluoro)alkyl chain, including fluorine-free alkyl sulfonates e.g. mesylate (methansulfonate) and fluorine containing (especially perfluorinated) alkyl sulfonates, e.g. triflate (trifluoromethansulfonate); halides (iodide, bromide, chloride) are particularly preferred because of their prompt accessibility from synthetic perspective.

As a whole, exemplary compounds which have been found particular utility in the composition of the present invention are those listed below having formulae (Ex-1) to (Ex-9):

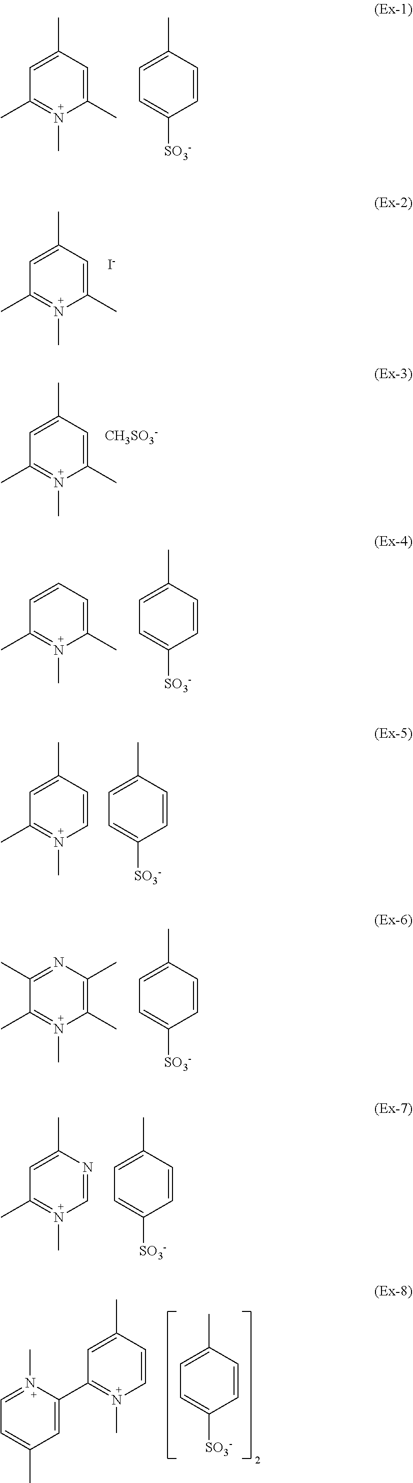

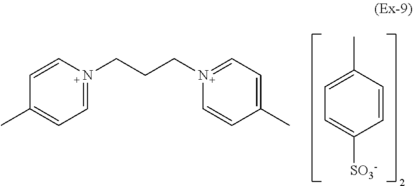

The composition of the invention generally comprises salt (P) in an amount of at least 0.1, preferably at least 0.5, more preferably at least 1 weight part per 100 weight parts of polymer (A) (phr).

The composition of the invention generally comprises salt (P) in an amount of at most 30, preferably at most 20, more preferably at most 15 weight parts per 100 weight parts of polymer (A).

The base (B) suitable for being used in the composition (C) of the present invention is not particularly limited. One or more than one organic base, one or more than one inorganic base or mixtures of organic and inorganic base(s) (B) can be used.

Among inorganic bases [bases (IB)] mention can be notably made of:

i) divalent metal oxides, in particular oxides of alkali-earth metals or oxides of Zn, Mg, Pb, Ca, including specifically MgO, PbO and ZnO;
ii) hydroxides of metals, in particular hydroxides of monovalent and divalent metals, specifically hydroxides of alkali and alkali-earth metals, in particular hydroxides selected from the group consisting of of NaOH, KOH, Ca(OH)₂, Sr(OH)₂, and Ba(OH)₂;
(iii) metal salts of weak acids having a pKₐ higher than 3, in particular weak acids selected from the group consisting of carbonates, benzoates, oxalates and phosphites; in particular Na, K, Ca, Sr, Ba salts of carbonates, benzoates, oxalates and phosphites.

Among inorganic bases, NaOH has been found to be particularly effective.

Among organic bases [bases (OB)] mention can be notably made of:

(j) non-aromatic amines or amides complying with general formula (B1m) or (B1d):

R_{bm}—[C(O)]ₜ—NR^{H}₂ (B1 m)

R^{H}₂N—[C(O)]_{t′}—R_{dm}—[C(O)]_{t″}—NR^{H}₂ (B1d)

wherein:
each of t, t′ and t″, equal to or different from each other and at each occurrence is zero or 1;
each of R^{H} is independently H or a C₁-C₁₂ hydrocarbon group;
R_{bm} is a monovalent hydrocarbon non-aromatic group having 1 to 30 carbon atoms;
R_{bm} is a divalent hydrocarbon non-aromatic group having 1 to 30 carbon atoms; and
   (jj) cycloaliphatic secondary or tertiary amines complying with general formula (B2m) or (B2d):

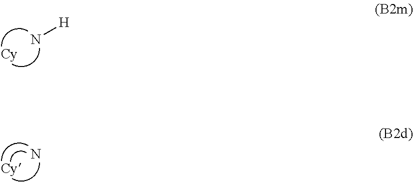

wherein:
Cy represents a divalent aliphatic group comprising at least 4 carbon atoms, optionally comprising one or more than one ethylenically unsaturated double bond, and optionally comprising one or more catenary nitrogen atoms, forming a cycle with the nitrogen atom which is connected thereto;
Cy′ represent a trivalent aliphatic group comprising at least 5 carbon atoms, optionally comprising one or more than one ethylenically unsaturated double bond, and optionally comprising one or more catenary nitrogen atoms, forming a cycle with the nitrogen atom which is connected thereto;
   (jjj) aromatic amines or amides complying with general formula (B3):

Ar_{b}—{[C(O)]ₜ—NR^{H}₂}_{w} (B3)

wherein:
t, equal to or different from each other and at each occurrence, is zero or 1;
w is an integer of 1 to 4;
each of R^{H} is independently H or a C₁-C₁₂ hydrocarbon group;
Ar_{b} is a mono- or poly-nuclear aromatic group, possibly comprising one or more than one catenary heteroatoms selected from the group consisting of S and O;
   (jv) heteroaromatic amines comprising at least one nitrogen atom comprised in a heteroaromatic cycle, in particular pyridine derivatives;
   (v) guanidine derivatives of formula (B4) or (B5):

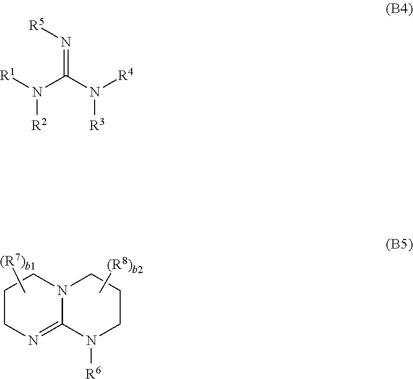

wherein:
each of R¹, R², R³, R⁴, R⁵, R⁶, R⁷, and R⁸, equal to or different from each other, is independently H or a C₁-C₁₂ hydrocarbon group and corresponding salts of said guanidines (B4) and (B5), in particular corresponding N-quaternized hydrohalides (preferably hydrochlorides);
   (vj) metal alkoxylates, preferably alkoxylates of aliphatic alcohols.

Among bases of formulae (B1m) and (B1d), those wherein:
R_{bm} is a monovalent aliphatic linear group having 6 to 30 carbon atoms, possibly comprising one or more than one ethylenically unsaturated double bond; and
R_{dm} is a divalent aliphatic linear group having 6 to 30 carbon atoms, possibly comprising one or more than one ethylenically unsaturated double bond, are particularly preferred.

Among the said non-aromatic amines or amides, mention can be particularly made of:
octadecylamine of formula CH₃(CH₂)₁₇—NH₂;
erucamide of formula H₂N—C(O)—(CH₂)₁₁—CH═CH—(CH₂)₇CH₃;
oleamide of formula H₂N—C(O)—(CH₂)₇—CH═CH—(CH₂)₇CH₃;
hexamethylenediamine of formula H₂N—(CH₂)₆—NH₂;
N,N-dimethyloctylamine;
N,N-dimethyldodecylamine;
trioctylamine;
trimethylamine;
trihexylamine.

Among the said cycloaliphatic secondary or tertiary amines, mention can be made of 1,8-diazabicycloundec-7-ene (DBU) of formula:

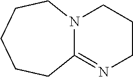 [SMILES: C1CCC2=NCCCN2CC1]

Exemplary embodiments of said guanidine derivatives of formula (B-4) are notably guanidine hydrochloride and di-o-tolylguanidine.

Exemplary embodiments of said metal alkoxylates are notably potassium terbutylate, sodium ethylate and sodium methylate.

Exemplary embodiments of said heteroaromatic amines are notably trimethylpyridine isomers.

The amount of base (B) will be adjusted by one of ordinary skills in the art, taking into account the nature and basicity of base (B) used.

It is nevertheless understood that the composition (C) generally comprises at least 0.1 weight parts of said base (B) (organic and/or inorganic, as above detailed), preferably at least 0.2 weight parts, more preferably at least 0.25 weight parts per 100 weight parts of polymer (A).

Further, the composition (C) generally comprises at most 30 weight parts of said base (B), preferably at most 25 weight parts, more preferably at least 20 weight parts per 100 weight parts of polymer (A).

The base (B) and the salt (P) may be added during manufacture of the composition (C) in a preliminary step, so as to generate corresponding carbanion of the salt (P).

As said, the composition (C) is an aqueous composition, that is to say it is a composition comprising a liquid medium which comprises water as major component.

While minor amounts of organic solvents may be present, it is generally understood that the liquid medium of the composition (C) essentially consists of water, and that solvents are present preferably in limited amounts, e.g. of less than 1% wt, with respect to the total weight of the composition (C), so as not to disadvantageously modify the aqueous nature of the composition, and all its advantageous environmental aspects.

The invention further pertains to a method of making composition (C), as above detailed, said method comprising mixing the aqueous latex of polymer (A), the base (B) and the salt (P), as above detailed.

Generally, the method according to the invention comprises a first step of mixing the base (B) and the salt (P) so as to obtain a pre-mix, and a second step of mixing the said pre-mix and the aqueous latex of polymer (A).

Generally, in the first step, the base (B) and the salt (P) are mixed in a liquid medium, and more specifically in an aqueous medium, i.e. a liquid medium essentially consisting of water. Minor amounts of one or more organic solvent(s) may be tolerated in the aqueous medium where mixing of base (B) and salt (P) is effected, provided their amount does not exceed 1% wt, based on the aqueous medium. Examples of organic solvent(s) which may be present as solubilization aids for the salt (P) are notably tetrahydrofurane (THF) and acetonitrile.

Base (B) and salt (P) are mixed in the first step in the said aqueous medium at a temperature of advantageously at least 10° C., preferably at least 15° C. and generally at most 60° C., more preferably at most 50° C., being understood that mixing at room temperature may be preferred, and is generally totally effective.

Without being bound by this theory, the Applicant believes that in this first step of forming the pre-mix of base (B) and salt (P), the reactive hydrogen atoms in ortho or para position with respect to the ring-quaternized pyridinium-type nitrogen of the salt (P) are removed, so as to provide for corresponding carbanion, which is the actual effective cross-linking agent for the polymer (A).

Mixing base (B) and salt (P) in the said aqueous medium can be performed in usual mixing devices, generally in vessels equipped with stirring means.

In the second step, the method includes mixing the pre-mix and the aqueous latex of polymer (A). Generally, the pre-mix is added step-wise to the aqueous latex of polymer (A); more specifically, addition of pre-mix formed in an aqueous medium may be effected drop-wise.

Mixing the aqueous latex of polymer (A) with base (B) and salt (P) or with the pre-mix thereof is generally effected in mixing devices, generally operating at low shear rate, so as to minimize shear stress-induced coagulation phenomena.

Mixing is generally carried out at temperatures of from 10 to 45° C., preferably of 15 to 35° C., being understood that mixing at room temperature may be preferred, and is generally totally effective.

The composition (C) so obtained may be processed into shaped finished parts (e.g. into films or coatings) and/or may be further formulated by addition of additional specific ingredients, depending on the final targeted field of use.

An aqueous electrode-forming composition may be obtained by adding and dispersing a powdery electrode material (an active substance for a battery or an electric double layer capacitor), and optional additives, such as an electroconductivity-imparting additive and/or a viscosity modifying agent, into the composition (C), as above detailed.

Also an object of the invention is thus an aqueous electrode-forming composition comprising composition (C), as above detailed, an electro-active substance (referred to, hereinafter, as “active substance”) and, optionally, an electroconductivity-imparting additive and/or a viscosity modifying agent.

Among viscosity modifying agents, a thickener may be added in order to prevent or slow down the settling of the powdery electrode material from the aqueous composition of the invention. Non-limitative examples of suitable thickeners include, notably, organic thickeners such as partially neutralized poly(acrylic acid) or poly(methacrylic acid), carboxylated alkyl cellulose like carboxylated methyl cellulose and inorganic thickeners such as natural clays like montmorillonite and bentonite, manmade clays like laponite and others like silica and talc.

In the case of forming a positive electrode for a lithium ion battery, the active substance may comprise a composite metal chalcogenide represented by a general formula of LiMY₂, wherein M denotes at least one species of transition metals such as Co, Ni, Fe, Mn, Cr and V; and Y denotes a chalcogen, such as O or S. Among these, it is preferred to use a lithium-based composite metal oxide represented by a general formula of LiMO₂, wherein M is the same as above. Preferred examples thereof may include: LiCoO₂, LiNiO₂, LiNiₓCo₁₋ₓO₂ (0<x<1), and spinel-structured LiMn₂O₄.

In the case of forming a negative electrode for a lithium battery, the active substance may preferably comprise a carbonaceous material, such as graphite, activated carbon or a carbonaceous material obtained by carbonization of phenolic resin, pitch, etc. The carbonaceous material may preferably be used in the form of particles having an average diameter of ca. 0.5-100 μm.

An electroconductivity-imparting additive may be added in order to improve the conductivity of a resultant composite electrode layer formed by applying and drying of the electrode-forming composition of the present invention, particularly in case of using an active substance, such as LiCoO 2, showing a limited electron-conductivity. Examples thereof may include: carbonaceous materials, such as carbon black, graphite fine powder and fiber, and fine powder and fiber of metals, such as nickel and aluminum.

The active substance for an electric double layer capacitor may preferably comprise fine particles or fibers, such as activated carbon, activated carbon fiber, silica or alumina particles, having an average particle (or fiber) diameter of 0.05-100 μm and a specific surface area of 100-3000 m²/g, i.e., having a relatively small particle (or fiber) diameter and a relatively large specific surface area compared with those of active substances for batteries.

The preferred electrode-forming composition for positive electrodes comprises:

(a) an amount of composition (C) such that polymer (A) is present in an amount from 1 to 10% wt, preferably from 2 to 9% wt, more preferably about 3% wt, with respect to the total weight (a)+(b)+(c);
(b) carbon black as electroconductivity-imparting additive, in an amount from 2 to 10% wt, preferably from 4 to 6% wt, more preferably about 5% wt, with respect to the total weight (a)+(b)+(c);
(c) a powdery electrode material, preferably a composite metal chalcogenide represented by a general formula of LiMY₂, as above detailed, in an amount from 80 to 97% wt, preferably from 85 to 94% wt, more preferably about 92% wt.

An aqueous coating composition suitable for coating separators can be obtained by adding and dispersing a non-electroactive inorganic filler material, and optional additives, into the composition (C), as above detailed.

Also an object of the invention is thus an aqueous coating composition [composition (AC)] comprising composition (C), as above detailed, at least one non-electroactive inorganic filler material and, optionally, one or more than one additional additive.

By the term “non-electroactive inorganic filler material”, it is hereby intended to denote an electrically non-conducting inorganic filler material which is suitable for the manufacture of an electrically insulating separator for electrochemical cells.

The non-electroactive inorganic filler material typically has an electrical resistivity (p) of at least 0.1×10¹⁰ ohm cm, preferably of at least 0.1×10 12 ohm cm, as measured at 20° C. according to ASTM D 257. Non-limitative examples of suitable non-electroactive inorganic filler materials include, notably, natural and synthetic silicas, zeolites, aluminas, titanias, metal carbonates, zirconias, silicon phosphates and silicates and the like. The non-electroactive inorganic filler material is typically under the form of particles having an average size of from 0.01 μm to 50 μm, as measured according to ISO 13321.

Optional additives in composition (AC) include notably viscosity modifiers, as detailed above, anti-foams, non-fluorinated surfactants, and the like.

Among non-fluorinated surfactants, mention can be made of non-ionic emulsifiers, such as notably alkoxylated alcohols, e.g. ethoxylates alcohols, propoxylated alcohols, mixed ethoxylated/propoxylated alcohols; of anionic surfactants, including notably fatty acid salts, alkyl sulfonate salts (e.g. sodium dodecyl sulfate), alkylaryl sulfonate salts, arylalkyl sulfonate salts, and the like.

The composition (AC) may be obtained from the composition (C), e.g. (i) by formulating composition (C) with optional additives, as above detailed, (ii) by upconcentrating composition (C), notably through standard techniques like ultra-filtration, clouding, and the like, (iii) by diluting composition (C) with water, or through a combination of above techniques.

Generally, the composition (AC) is obtained by mixing:

(i) composition (C), as above detailed, in an amount of from 5 to 25% wt;
(ii) at least one non-electroactive inorganic filler material, in an amount of from 70 to 95% wt;
(iii) optionally, one or more than one additional additive, in an amount of 0 to 5% wt; and optionally, adding water for adjusting solid contents in the range of 30 to 80% wt, preferably 40 to 60% wt.

The solid contents of the composition (AC) is understood to be cumulative of all non-volatile ingredients thereof, notably including polymer (A) and non-electroactive inorganic filler material.

Still another object of the present invention is a method for the manufacture of a composite separator notably suitable for use in an electrochemical cell, said method comprising the following steps:

(i) providing a porous substrate;
(ii) providing an aqueous coating composition comprising composition (A), as above detailed, at least one non-electroactive inorganic filler material and, optionally, at least one or more than one additional additive, i.e. the composition (AC), as above detailed;
(iii) applying said composition (AC) onto at least one surface of said porous substrate to provide a coating composition layer; and
(iv) drying said coating composition layer at a temperature of at least 60° C., to provide said composite separator.

By the term “separator”, it is hereby intended to denote a porous polymeric material which electrically and physically separates electrodes of opposite polarities in an electrochemical cell and is permeable to ions flowing between them.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

The composite separator obtained from the method of the invention is advantageously an electrically insulating composite separator suitable for use in an electrochemical cell.

In step (iii) of the method of the invention, the composition (AC) is typically applied onto at least one surface of the porous substrate by a technique selected from casting, spray coating, roll coating, doctor blading, slot die coating, gravure coating, ink jet printing, spin coating and screen printing, brush, squeegee, foam applicator, curtain coating, vacuum coating.

Non-limitative examples of suitable porous substrate include, notably, porous membranes made from inorganic, organic and naturally occurring materials, and in particular made from nonwoven fibers (cotton, polyamides, polyesters, glass), from polymers (polyethylene, polypropylene, poly(tetrafluoroethylene), poly(vinyl chloride), and from certain fibrous naturally occurring substances (e.g. asbestos).

Advantageous results have been obtained when the porous support was a polyolefin porous support, e.g. a polyethylene or a polypropylene porous support.

In step (iv) of the method of the invention, the coating composition layer is dried preferably at a temperature comprised between 60° C. and 200° C., preferably between 70° C. and 180° C.

Should the disclosure of any of the patents, patent applications, and publications that are incorporated herein by reference conflict with the present description to the extent that it might render a term unclear, the present description shall take precedence.

The invention will be now described with reference to the following examples, whose purpose is merely illustrative and not intended to limit the scope of the invention.

### EXAMPLES

### Preparative Example 1—1,2,4,6-tetramethyl-pyridinium p-toluenesulphonate of Formula (Ex-1)

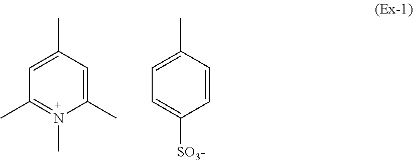

(herein below referred to as 3-Py)

A three-necked round bottom flask equipped with thermometer, condenser and stirring was charged with CH₂Cl₂ (85 ml) and methyl-p-toluenesulphonate (25.50 g). Then 2,4,6 trimethylpyridine (16.59 g) was added drop-wise at room temperature. The reaction was stirred at 50° C. and, after 22 hours, it was completed. The liquid phase was removed by evaporation under vacuum obtaining a white powder that was dispersed in diethyl-ether (50 ml) under stirring. The liquid phase was filtered off and 39.13 g of pure product was recovered as a white powder in 93% yield (melting point 161° C.; 1% weight loss: 266° C.).

¹H NMR (solvent D₂O, TMS reference): +7.70 ppm (d; 2H; ortho-H; p-toluenesulphonate); +7.55 (s; 2H; meta-H; 1,2,4,6-tetramethyl-pyridinium); +7.39 (d; ²H; meta-H; p-toluenesulphonate); +4.0 (s; 3H; NCH₃; 1,2,4,6-tetramethyl-pyridinium); +2.74 (s; 6H; ortho-CH3; 1,2,4,6-tetramethyl-pyridinium); 2.53 (s; 3H; para-CH₃; 1,2,4,6-tetramethyl-pyridinium); +2.44 ppm (s; 3H; para-CH₃; p-toluenesulphonate).

### Preparative Example 4—1,2,6-trimethyl-pyridinium p-toluenesulphonate of Formula (Ex-4)

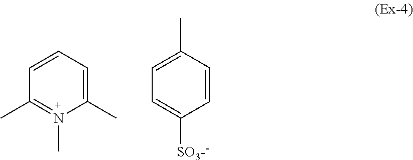

(herein below referred to as 2-Py)

A three-necked round bottom flask equipped with thermometer, condenser and stirring was charged with CH₂Cl₂ (163 ml) and methyl-p-toluenesulphonate (52.14 g). Then 2,6 dimethylpyridine (30 g) was added drop-wise at room temperature. The reaction was stirred at 50° C. and, after 23 hours, it was completed. The liquid phase was removed by evaporation under vacuum obtaining a white powder that was dispersed in diethyl-ether (200 ml) under stirring. The liquid phase was filtered off and 58.06 g of pure product was recovered as a white powder in 71% yield (melting point 157.6° C.; 1% weight loss: 256° C.).

¹H NMR (solvent D₂O, TMS reference): +8.14 ppm (t; 1H; para-H; 1,2,6-trimethyl-pyridinium); +7.66 ppm (m; 4H; ortho-H; p-toluenesulphonate and meta-H; 1,2,6-trimethyl-pyridinium); +7.33 (d; 2H; meta-H; p-toluenesulphonate); +4.00 (s; 3H; NCH₃; 1,2,6-trimethyl-pyridinium); +2.74 (s; 6H; ortho-CH₃; 1,2,6-trimethyl-pyridinium); +2.38 ppm (s; 3H; para-CH₃; p-toluenesulphonate).

General Procedure

Preparation of Pyridinium Salt and Base Solutions

Procedure A)

2Py: to solution of 1,2,6-trimethyl-pyridinium p-toluenesulphonate (0.58 g; 1.98 mmol) in water (4 ml), a solution of sodium hydroxide (0.18 g, 4.47 mmol) in water (1.5 ml) was added. The mixture was stirred for 2.5 hours at room temperature.

Procedure B)

3Py: to solution of 1,2,4,6-tetramethyl-pyridinium p-toluenesulphonate (0.61 g; 1.98 mmol) in water (4 ml), a solution of sodium hydroxide (0.25 g, 6.21 mmol) in water (1.5 ml) was added. The mixture was stirred for 2.5 hours at room temperature.

Procedure C)

3Py: to solution of 1,2,4,6-tetramethyl-pyridinium p-toluenesulphonate (0.61 g; 1.98 mmol) in water (4 ml), a solution of sodium hydroxide (0.4 g, 9.94 mmol) in water (1.5 ml) was added. The mixture was stirred for 2.5 hours at room temperature.

Procedure D)

3Py: to solution of 1,2,4,6-tetramethyl-pyridinium p-toluenesulphonate (0.68 g; 2.32 mmol) in water (25 ml), a solution of sodium hydroxide (0.18 g, 2.70 mmol) in water (0.4 ml) was added. The mixture was stirred for 2.5 hours at room temperature

Preparation of the Coating Composition and Casting Procedure

To 50 g of latex of polymer (A) an aqueous solution of ammonia was added in an amount such as to achieve a pH value ranging around 8-9. The pyridinium salt and base solution prepared according to any of methods A, B, or C, detailed above, was added dropwise. Then, casting was performed on glass surface by using a casting knife at 30 μm of blade height and the resulting wet coated layer on glass support was heated in a oven for 2 hours at 90° C. The resulting film was washed with water (2×1 L), so as to remove any unreacted pyridinium salt, which is highly soluble in water.

The properties of the different VDF polymer latexes used are summarized in the following table:

TABLE 1

| Latex of | | | Acrylic | Solid |
|---|---|---|---|---|
| polymer | VDF | HFP | Acid | Content |
| (A) (i.d.) | (% mol) | (% mol) | (% mol) | (% wt) |
| A1 | 96.0 | 3.0 | 1.0 | 23.6 |
| A2 | 78.0 | 22.0 | 1.0 | 23.3 |
| A3 | 99.0 | 1.0 | 1.0 | 24.8 |
| A4 | 99.6 | — | 0.4 | 24.1 |
| A5 | 80.0 | 20.0 | — | 22.5 |
| A6 | 94.0 | 6.0 | — | 24.8 |
| A7 | 99.0 | 1.0 | — | 23.1 |

The coating compositions prepared therefrom in combination with pyridium salts 3-Py and 2-Py and a base are described in the following table.

TABLE 2

| | | | NaOH (wt parts per |
|---|---|---|---|
| | Polymer (A) | Pyridinium Salt | 100 parts of |
| Example | latex | (nature) | polymer) |
| 3 | A1 | 2Py | Procedure A (1.50) |
| 4 | A1 | 3Py | Procedure B (2.10) |
| 5 (Comparative) | A1 | — | — |
| 6 (Comparative) | A1 | — | (1.50)* |
| 7 | A2 | 2Py | Procedure A (1.55) |
| 8 | A2 | 3Py | Procedure B (2.15) |
| 9 (comparative) | A2 | — | — |
| 10 | A3 | 2Py | Procedure A (1.45) |
| 11 | A3 | 3Py | Procedure B (2.00) |
| 12 (comparative) | A3 | — | — |
| 13 | A3 | 3Py | Procedure C (3.20) |
| 14 | A4 | 2Py | Procedure A (1.50) |
| 15 | A4 | 3Py | Procedure B (2.10) |
| 16 (comparative) | A4 | — | — |
| 17 | A5 | 3Py | Procedure C (3.50) |
| 18 (comparative) | A5 | — | — |
| 19 | A6 | 2Py | Procedure A (1.45) |
| 20 | A6 | 3Py | Procedure B (2.20) |
| 21 | A6 | 3Py | Procedure C (3.20) |
| 22 (comparative) | A6 | — | — |
| 23 | A7 | 2Py | Procedure A (1.55) |
| 24 (comparative) | A7 | — | — |

*NaOH aqueous solution directly added to the latex before casting

Characterizations

Insoluble content either in dimethylacetamide (DMA), tetrahydrofurane (THF) or dimethylformamide (DMF), IR spectra and apparent viscosity were determined on specimens taken out from the films, as obtained above.

Insoluble content in DMA has been determined dissolving the specimen 0.25% wt/vol in DMA+LiBr 0.01N at 45° C., under stirring for two hours and further centrifugation at 20000 rpm for 60 minutes at room temperature using a Sorvall RC-6 Plus centrifuge (rotor model: F21S-8X50Y).

Insoluble content in THF has been determined dissolving the specimen 0.5% wt/vol in THF at 35° C., under stirring) for four hours and further filtration with PTFE filter 0.45 micron.

Insoluble content in DMF has been determined dissolving the specimen 0.2% wt/vol in DMF at room temperature, under stirring for two hours and further centrifugation at 20000 rpm for 60 minutes at room temperature using a Sorvall RC-6 Plus centrifuge (rotor model: F21S-8X50Y).

For determining apparent viscosity, frequency sweep test was performed (according ASTM D 4440) in a rheogoniometer rheometrics RMS 800 in a parallel plate configuration (d=25 mm) at 230° C. Viscosity η* (Pa*s) were determined at frequency of oscillation 0.01 rad/s.

IR spectra were inspected for the presence of characteristics absorption peaks at wavelength of 1625/1580 cm⁻¹ of pyridinium salts.

Table of Results

TABLE 3

| | DMA | DMF | η* at | Py salts |
|---|---|---|---|---|
| | insoluble | insoluble | 0.01 rad/s | IR bands |
| Examples | (% wt) | (% wt) | (Pa*s) | (Y/N) |
| 3 | 45 | 32 | 1 × 10⁷ | Y |
| 4 | 71 | 64 | 1 × 10⁷ | Y |
| 5 (comparative) | 24 | 26 | 0.5 × 10⁶ | N |
| 6 (comparative) | 37 | n.a. | n.d. | N |
| 7 | 5 (THF) | n.a. | 3 × 10⁵ | Y |
| 8 | 7 (THF) | n.a. | 2 × 10⁶ | Y |
| 9 (comparative) | 8 (THF) | n.a. | 2 × 10⁵ | N |
| 10 | 60 | 56 | 2 × 10⁷ | Y |
| 11 | 40 | 56 | 3 × 10⁷ | Y |
| 12 (comparative) | 43 | 42 | 3 × 10⁶ | N |
| 13 | 69 | 72 | 3 × 10⁷ | Y |
| 14 | 27 | 19 | 2 × 10⁵ | Y |
| 15 | 28 | 24 | 9 × 10⁵ | Y |
| 16 (comparative) | 18 | 21 | 1 × 10⁵ | N |
| 17 | 13 (THF) | n.a. | 4 × 10⁴ | Y |
| 18 (comparative) | <3 (THF) | n.a. | 7 × 10³ | N |
| 19 | 47 | 38 | n.a. | Y |
| 20 | 51 | 54 | 4 × 10⁶ | Y |
| 21 | 82 | >89 | 1.5 × 10⁷ | Y |
| 22 (comparative) | <3 | <3 | 2 × 10⁴ | N |
| 23 | 41 | 33 | 2 × 10⁶ | Y |
| 24 (comparative) | 29 | 31 | 1 × 10⁵ | N |

n.a.: not available.

All data collected consistently demonstrate that the VDF polymer in the films so obtained has undergone significant crosslinking, as measured through an increase in insoluble fraction in different solvents, and/or through increase of the apparent viscosity in the molten state. These films were found to be endowed with improved mechanical properties and improved cohesion to fillers. Further, the films were found to comprise IR fingerprints of the presence of pyridinium salts residues.

Preparation of the Coating Composition and Casting Procedure Based on Elastomeric Polymer

In this additional series of tests, TECNOFLON® TN latex was used; this commercially available latex has a solids content of 65-67% wt, comprising particles of a TFE/HFP/VDF terpolymer (with a VDF content of about 65% moles), stabilized with a non-ionic alkoxy ethoxylated surfactant. This polymer latex will be referred hereunder as polymer (A^{FKM}).

To 100 g of latex of polymer (A^{FKM}) an aqueous solution of ammonia was added in an amount such as to achieve a pH value ranging around 8-9. The pyridinium salt and base solution prepared according to method D, detailed above, was added dropwise. The mixture was left in agitation (18-22° C.) for 60 minutes. Then, casting was performed on a chromated aluminium Q-panel® test-substrate, by casting the latex on the substrate in a manner so as to completely coat the surface. The coated panels were left to dry at room temperature for 6-8 hours in air, and were then backed at 90° C. for 60 minutes in an air oven.

For comparison, samples of latex of polymer (A^{FKM}) were added with a different type of crosslinker (hexamethylene diamine (EMDA)), according to similar technique. A portion of 100 g of latex was basified up to pH 9 through addition of ammonia and then was formulated with 3.4 g of EMDA: the system was left in agitation (at 18-22° C.) for 60 minutes.

Table below summarizes results obtained using latex of polymer (A^{FKM}), including without any added crosslinking agent.

TABLE 5

| | | Pyridinium Salt | |
|---|---|---|---|
| | | or X-linking | NaOH (wt parts per |
| | Polymer (A) | agent | 100 parts of |
| Example | latex | (nature) | polymer) |
| 25 | A^{FKM} | 3Py | Procedure D (0.3) |
| 26 (Comparative) | A^{FKM} | EM DA | |
| 27 (Comparative) | A^{FKM} | — | — |

Characterization of Materials Produced in the Examples 25, 26C and 27C

Determination of Brookfield Viscosity on Latexes

The formulations obtained in Ex. 25, 26C and 27C were submitted to Brookfield viscosity measurements (measured at 20° C. and at 35° C. with Brookfield viscosimeter, model DVI, speed 20 rpm) immediately after preparation, after one day and after eight days (samples were stored in the meanwhile at 18-22° C.). The test was performed according to ASTM D 2196.

Determination of Insoluble Polymer in MEK

10 g of each formulated composition was heated and dried in vented stove at 105° C. for one hour. Insoluble content in Methyl Ethyl Ketone (MEK) was determined dissolving the specimen 8.1% wt/vol in MEK at 18-22° C., under stirring for two hours and further filtration of the solution through a net 50 μm; the residual part remained onto the net was dried at 105° C. and weighed: these data allowed to determine the insoluble polymer in MEK according to the following formula:

% Insoluble polymer in MEK=[(dried residual polymer)/(initial weight of polymer)]×100

where:
initial weight of polymer=the weight of the specimen before introduction into the MEK solution
dried residual polymer=the weight of the insoluble residue collected by filtration and dried.

Results of Characterizations

The results of characterizations are summarized in Table below:

TABLE 6

| | Viscosity 20° C. | | | Viscosity 35° C. | | | Insoluble |
|---|---|---|---|---|---|---|---|
| | (cPs) | | | (cPs) | | | polymer in |
| Ex. | time 0 | 1 day | 8 days | time 0 | 1 day | 8 days | MEK (%) |
| 25 | 6 | 4 | 18 | 7 | 6 | 13 | 66 |
| 26C | 16 | 250 | Out of | 15 | 310 | Out of | 85 |
| | | | range | | | range | |
| 27C | 17 | 16 | 17 | 8 | 6 | 14 | 0 |

The data about insoluble polymer in MEK demonstrated that adequate crosslinking was achieved with the composition of the present invention including py3 salt and base.

Broookfiled viscosity, measured both at 20° C. and 35° C., significantly increased for formulation comprising EMDA crosslinker, as a clear indication of lack of shelf stability for this crosslinkable composition of the prior art. In similar conditions, the formulation of the invention was found to possess significantly higher stability, enabling storage of the formulated dispersion for at least 8 days, with no significant impact on liquid viscosity, and hence maintaining filmability and processability for long period of time after formulation: this stability is a further advantage of the coating composition of the present invention, with respect to traditional formulations including EMDA crosslinker.

1. An aqueous composition (C) obtained by mixing:
an aqueous latex comprising particles of at least one polymer (A), wherein polymer (A) is at least one vinylidene-fluoride (VDF) based fluoropolymer comprising recurring units derived from vinylidene fluoride (VDF) and optionally from at least one additional comonomer different from VDF;
at least one base (B), wherein base (B) is at least one basic compound;
at least one pyridinium salt (P) complying with any of formulae (P-1) to (P-12): 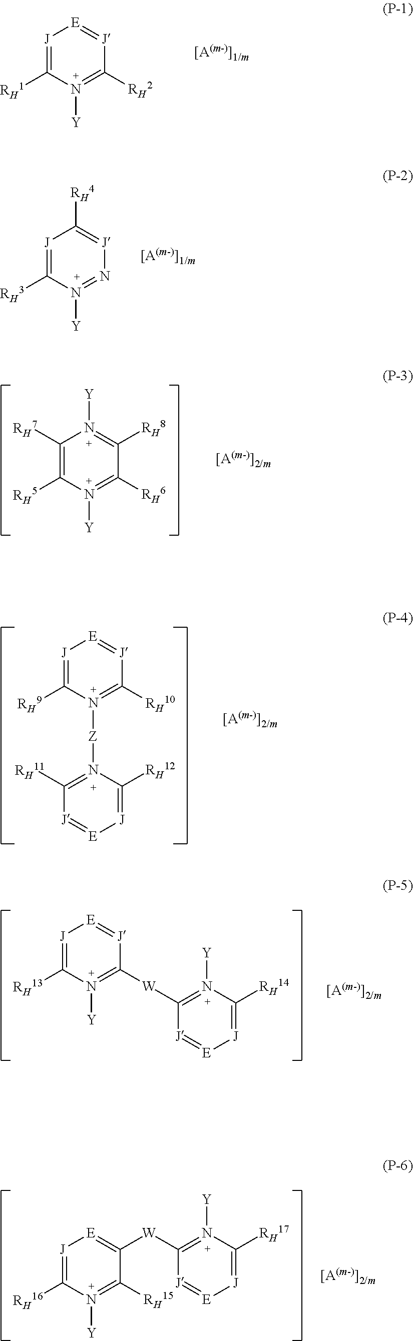 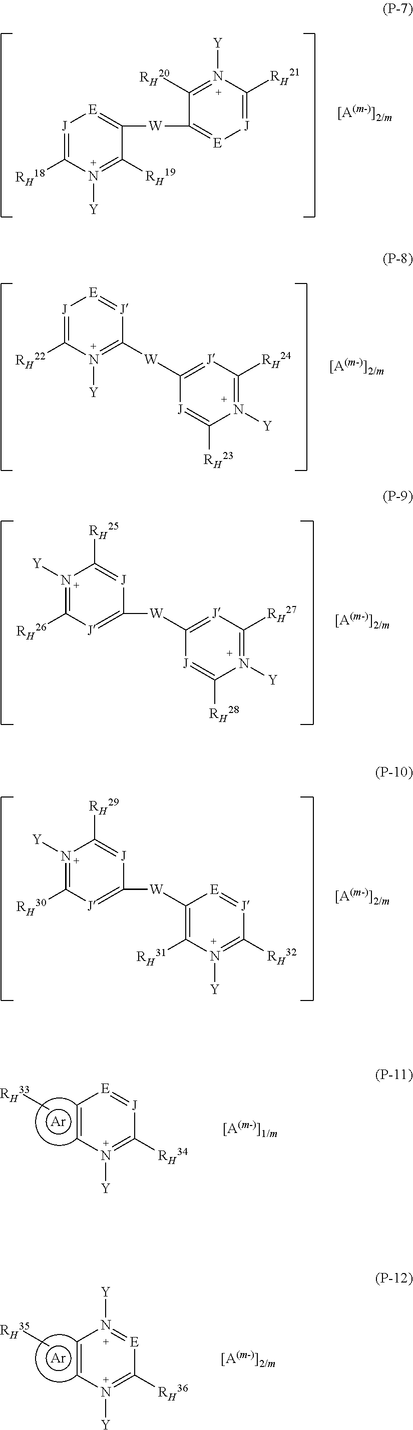
wherein:
each of J and J′, equal to or different from each other, is independently at each occurrence C—R* or N, wherein R* is H or a C₁-C₁₂ hydrocarbon group;
E is N or a group of formula C—R^{∘}_{H};
W is a bond or is a bridging group selected from the group consisting of divalent hydrocarbon groups comprising from 1 to 12 carbon atoms and divalent fluorocarbon groups comprising from 1 to 12 carbon atoms;
the group sketched with symbol: 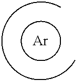
in formula (P-11) and (P-12) designates an aromatic mono- or poly-nuclear ring condensed to the pyridinium-type aromatic ring, which optionally comprises one or more additional nitrogen atoms, optionally quaternized nitrogen atoms, in the ring(s);
each of R¹_{H}, R²_{H}, R³_{H}, R⁴_{H}, R⁵_{H}, R⁶_{H}, R⁷_{H}, R⁸_{H}, R⁹_{H}, R¹⁰_{H}, R¹¹_{H}, R¹²_{H}, R¹³_{H}, R¹⁴_{H}, R¹⁵_{H}, R¹⁶_{H}, R¹⁷_{H}, R¹⁸_{H}, R¹⁹_{H}, R²⁰_{H}, R²¹_{H}, R²²_{H}, R²³_{H}, R²⁴_{H}, R²⁵_{H}, R²⁶_{H}, R²⁷_{H}, R²⁸H R²⁹_{H}, R³⁰_{H}, R³¹_{H}, R³²_{H}, R³³_{H}, R³⁴_{H}, R³⁵_{H}, R³⁶_{H} and R^{∘}_{H}, equal to or different from each other, is independently at each occurrence —H or group (alpha-H), wherein group (alpha-H) is a group of formula: 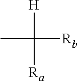
wherein Rₐ, and R_{b}, equal to or different from each other, are independently H or a hydrocarbon C₁-C₆ group;
Y, equal to or different from each other, is independently oxygen or a C₁-C₁₂ hydrocarbon group, optionally comprising one or more than one heteroatoms selected from N, O, S and halogens;
A^{(m-)} is an anion having valency m;
with the proviso that
(i) when salt (P) is of formula (P-1) at least two of R¹_{H}, R²_{H}, and R^{∘}_{H} are groups (alpha-H);
(ii) when salt (P) is of formula (P-2) R³_{H} and R⁴_{H} are groups (alpha-H);
(iii) when salt (P) is of formula (P-3), at least two of R⁵_{H}, R⁶_{H}, R⁷_{H}, and R⁸_{H} are groups (alpha-H);
(iv) when salt (P) is of formula (P-4), at least two of R⁹_{H}, R¹⁰_{H}, R¹¹_{H}, R¹²_{H}, and R^{∘}_{H} are groups (alpha-H);
(v) when salt (P) is of formula (P-5), at least two of R¹³_{H}, R¹⁴_{H}, and R^{∘}_{H} are groups (alpha-H);
(vi) when salt (P) is of formula (P-6), at least two of R¹⁵_{H}, R¹⁶_{H}, R¹⁷_{H}, and R^{∘}_{H} are groups (alpha-H);
(vii) when salt (P) is of formula (P-7), at least two of R¹⁸_{H}, R¹⁹_{H}, R²⁰_{H}, R²¹_{H}, and R^{∘}_{H} are groups (alpha-H);
(viii) when salt (P) is of formula (P-8), at least two of R²²_{H}, R²³_{H}, R²⁴_{H}, and R^{∘}_{H} are groups (alpha-H);
(ix) when salt (P) is of formula (P-9), at least two of R²⁵_{H}, R²⁶_{H}, R²⁷_{H}, and R²⁸_{H} are groups (alpha-H);
(x) when salt (P) is of formula (P-10), at least two of R²⁹_{H}, R³⁰_{H}, R³¹_{H}, R³²_{H}, and R²⁸_{H} are groups (alpha-H);
(xi) when salt (P) is of formula (P-11), at least two of R³³_{H}, R³⁴_{H}, and R²⁸_{H} are groups (alpha-H);
(xii) when salt (P) is of formula (P-12), at least two of R³⁵_{H}, R³⁶_{H} and R^{∘}_{H} are groups (alpha-H).

2. The composition (C) of claim 1, wherein polymer (A) comprises:
recurring units derived from vinylidene fluoride (VDF) in an amount ranging from 60 to 100% moles,
and optionally, recurring units derived from at least one additional comonomer C wherein comonomer (C) is different from VDF, in an amount ranging from 0 to 40% moles.

3. The composition (C) of claim 1, wherein the comonomer (C) is either a hydrogenated comonomer (H), which is an ethylenically unsaturated comonomer free of fluorine atoms; or a fluorinated comonomer (F), which is an ethylenically unsaturated comonomer comprising at least one fluorine atom.

4. The composition (C) according to claim 3, wherein polymer (A) comprises recurring units derived from derived from vinylidene fluoride (VDF) and from at least one hydrophilic (meth)acrylic monomer (MA), optionally in combination with one or more than one fluorinated comonomer (F), wherein said hydrophilic (meth)acrylic monomer (MA) complies with formula: 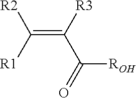
wherein each of R1, R2, R3, equal or different from each other, is independently a hydrogen atom or a C₁-C₃ hydrocarbon group, and R_{OH} is a hydroxyl group or a C₁-C₅ hydrocarbon moiety comprising at least one hydroxyl group.

5. The composition (C) according to claim 1, wherein polymer (A) is selected from fluoroelastomers (A) having following compositions (in mol % with respect to total moles of units of fluoroelastomer (A)):
(i) vinylidene fluoride (VDF) 45-85%; hexafluoropropene (HFP) 15-45%; tetrafluoroethylene (TFE) 0-30%;
(ii) vinylidene fluoride (VDF) 20-30%; hexafluoropropene (HFP) 18-27%; C₂-C₈ non-fluorinated olefins (01) 5-30%; perfluoroalkyl vinyl ethers (PAVE) 0-35%; bis-olefin (OF) 0-5%;
(iii) vinylidene fluoride (VDF) 60-75%; hexafluoropropene (HFP) 10-25%; tetrafluoroethylene (TFE) 0-20%; perfluoroalkyl vinyl ethers (PAVE) 1-15%.

6. The composition (C) according to claim 1, wherein the salts (P) of formula (P-1) are selected from the group consisting of salts having any of formulae (P-1-g) to (P-1-p): 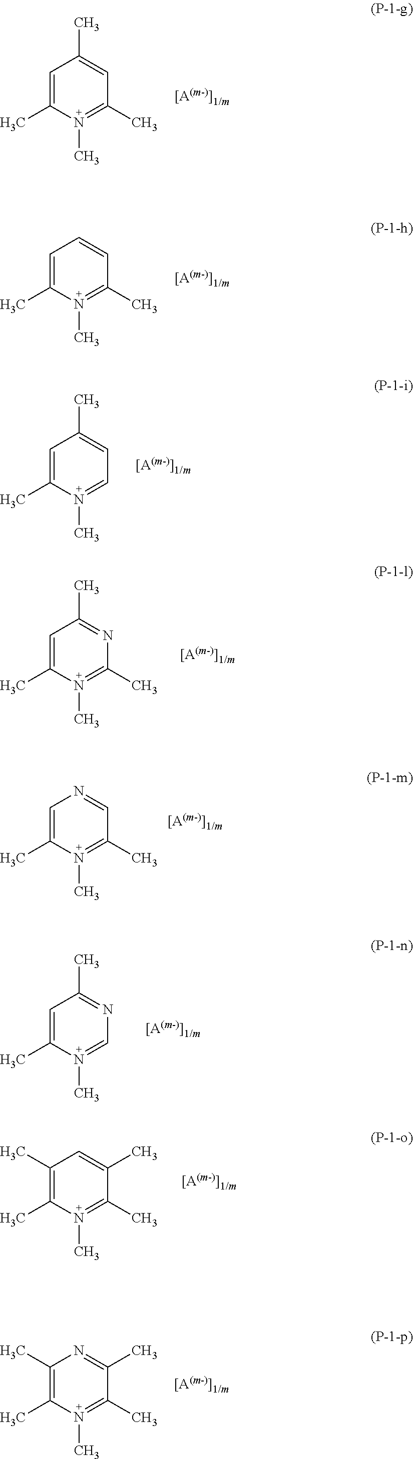
wherein A^{(m-)} is an anion having valency m.

7. The composition (C) according to claim 1, wherein the composition (C) comprises salt (P) in an amount of at least 0.1 weight part per 100 weight parts of polymer (A) (phr) and/or in an amount of at most 20 weight parts per 100 weight parts of polymer (A).

8. The composition (C) according to claim 1, wherein the base (B) is selected from the group consisting of (i) one or more than one organic base, (ii) one or more than one inorganic base and (iii) mixtures of organic and inorganic base(s).

9. The composition of claim 8, wherein base (B) is an inorganic base selected from the group consisting of:
i) divalent metal oxides;
ii) hydroxides of metals;
(iii) metal salts of weak acids having a pKₐ higher than 3.

10. The composition of claim 8, wherein base (B) is an organic base selected from the group consisting of:
(j) non-aromatic amines or amides complying with general formula (B1m) or (B1d):
R_{bm}—[C(O)]ₜ—NR^{H}₂ (B1m)
R^{H}₂N—[C(O)]_{t′}—R_{dm}—[C(O)]_{t″}—NR^{H}₂ (B1d)
wherein:
each of t, t′ and t″, equal to or different from each other and at each occurrence is zero or 1;
each of R^{H} is independently H or a C₁-C₁₂ hydrocarbon group;
R_{bm} is a monovalent hydrocarbon non-aromatic group having 1 to 30 carbon atoms;
R_{bm} is a divalent hydrocarbon non-aromatic group having 1 to 30 carbon atoms; and
(jj) cycloaliphatic secondary or tertiary amines complying with general formula (B2m) or (B2d): 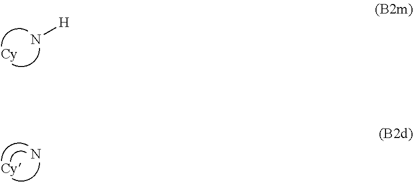
wherein:
Cy represents a divalent aliphatic group comprising at least 4 carbon atoms, optionally comprising one or more than one ethylenically unsaturated double bond, and optionally comprising one or more catenary nitrogen atoms, forming a cycle with the nitrogen atom which is connected thereto;
Cy′ represent a trivalent aliphatic group comprising at least 5 carbon atoms, optionally comprising one or more than one ethylenically unsaturated double bond, and optionally comprising one or more catenary nitrogen atoms, forming a cycle with the nitrogen atom which is connected thereto;
(jjj) aromatic amines or amides complying with general formula (B3):
Ar_{b}—{[C(O)]ₜ—NR^{H}₂}_{w} (B3)
wherein:
t, equal to or different from each other and at each occurrence, is zero or 1;
w is an integer of 1 to 4;
each of R^{H} is independently H or a C₁-C₁₂ hydrocarbon group;
Ar_{b} is a mono- or poly-nuclear aromatic group, optionally comprising one or more than one catenary heteroatoms selected from the group consisting of S and O;
(jv) heteroaromatic amines comprising at least one nitrogen atom comprised in a heteroaromatic cycle;
(v) guanidine derivatives of formula (B4) or (B5): 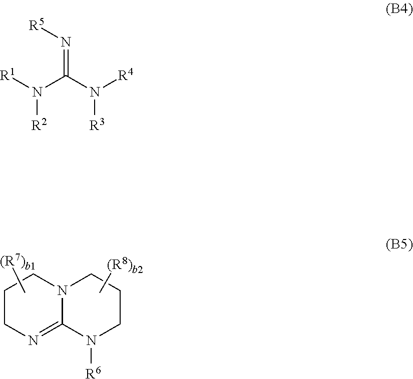
wherein:
each of R¹, R², R³, R⁴, R⁵, R⁶, R⁷, and R⁸, equal to or different from each other, is independently H or a C₁-C₁₂ hydrocarbon group
and corresponding salts of said guanidines (B4) and (B5);
(vj) metal alkoxylates.

11. The composition according to claim 1, wherein the composition (C) comprises from 0.1 to 20 weight parts of said base (B) per 100 weight parts of polymer (A).

12. A method of making the composition (C) according to claim 1, said method comprising a first step of mixing the base (B) and the salt (P) so as to obtain a pre-mix, and a second step of mixing the pre-mix and the aqueous latex of polymer (A).

13. An aqueous electrode-forming composition comprising the composition (C) according to claim 1, an electro-active substance, and, optionally, an electroconductivity-imparting additive and/or a viscosity modifying agent.

14. The aqueous electrode-forming composition of claim 13, said composition comprising:
(a) an amount of composition (C) such that polymer (A) is present in an amount from 1 to 10% wt, with respect to the total weight (a)+(b)+(c);
(b) carbon black as electroconductivity-imparting additive, in an amount from 2 to 10% wt, with respect to the total weight (a)+(b)+(c);
(c) a powdery electrode material, in an amount from 80 to 97% wt, with respect to the total weight (a)+(b)+(c).

15. An aqueous coating composition (AC) comprising composition (C) according to claim 1, at least one non-electroactive inorganic filler material and, optionally, one or more than one additional additive.

16. A method for the manufacture of a composite separator notably suitable for use in an electrochemical cell, said method comprising the following steps:
applying an aqueous coating composition comprising composition (A), according to claim 1, at least one non-electroactive inorganic filler material and, optionally, at least one or more than one additional additive;
onto at least one surface of a porous substrate to provide a coating composition layer; and
drying said coating composition layer at a temperature of at least 60° C., to provide said composite separator.

17. The composition (C) of claim 2, wherein polymer (A) comprises:
recurring units derived from vinylidene fluoride (VDF) in an amount ranging from 75 to 100% moles,
and recurring units derived from comonomer (C) in an amount ranging from 0 to 25% moles.

18. The composition (C) of claim 3, wherein the hydrogenated comonomer (H) is selected from the group consisting of acrylic monomers, styrene monomers, ethylene, propylene, vinyl monomers, vinyl acetate, styrene and p-methylstyrene; and wherein the fluorinated comonomer (F) is selected from the group consisting of:
(a) C₂-C₈ perfluoroolefins;
(b) C₂-C₈ hydrogen-containing fluoroolefins;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins;
(e) (per)fluoroalkylvinylethers of formula CF₂═CFOR_{f1}, wherein R_{f1} is a C₁-C₆ fluoro- or perfluoroalkyl group;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups;
(g) fluoroalkyl-methoxy-vinylethers of formula CF₂═CFOCF₂OR_{f2}, wherein R_{f2} is a C₁-C₆ fluoro- or perfluoroalkyl group or a C₁-C₆ (per)fluorooxyalkyl group having one or more ether groups;
(h) fluorodioxoles of formula: 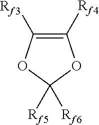
wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms.

19. The composition (C) according to claim 7, wherein the composition (C) comprises salt (P) in an amount of at least 1 weight part per 100 weight parts of polymer (A) (phr) and in an amount of at most 10 weight parts per 100 weight parts of polymer (A).

20. The aqueous electrode-forming composition of claim 13, wherein the electro-active substance comprises:
a composite metal chalcogenide represented by a general formula of LiMY₂, wherein M denotes at least one species of transition metals and Y denotes a chalcogen; or
a carbonaceous material.
